(19) United States
(12) Patent Application Publication
(10) Pub. No.: US 2013/0195190 A1
(43) Pub. Date: Aug. 1, 2013

(54) METHOD FOR DECIDING MOTION PARTITION MODE AND ENCODER

(71) Applicant: Electronics and Telecommunications Research Institute, Daejeon (KR)

(72) Inventors: Suk Ho Lee, Daejeon (KR); Nak Woong Eum, Daejeon (KR)

(73) Assignee: Electronics and Telecommunications Research Institute, Daejeon (KR)

(21) Appl. No.: 13/750,151

(22) Filed: Jan. 25, 2013

(30) Foreign Application Priority Data
Jan. 26, 2012 (KR) 10-2012-0008023

(51) Int. Cl. H04N 7/26

(52) U.S. Cl. CPC H04N 19/00684
USPC 375/240.16

(57) ABSTRACT

Disclosed are a method for deciding a motion partition mode and an encoder. The method for deciding a motion partition mode includes reading, a motion partition mode decision unit, motion vector information of more than one neighboring block decided as an inter mode among neighboring blocks of a current prediction unit C₀ from a motion vector storage unit; and deciding, by the motion partition mode decision unit, the motion partition mode for the current prediction unit using the read motion vector information. In accordance with the embodiments of the present invention, it is possible to perform the real-time encoding in the high-resolution and high-complexity video by shortening the time required for the motion estimation and improving the performance of the encoder.

### CROSS-REFERENCES TO RELATED APPLICATIONS

The present application claims priority under 35 U.S.C 119(a) to Korean Application No. 10-2012-0008023, filed on Jan. 26, 2012, in the Korean Intellectual Property Office, which is incorporated herein by reference in its entirety set forth in full.

### BACKGROUND

Exemplary embodiments of the present invention relate to a method for deciding a motion partition mode and an encoder, and more particularly, to a method for deciding a motion partition mode capable of rapidly deciding a motion partition mode of a current prediction unit using motion vector information of neighboring blocks and an encoder.

Recently, as resolution of a screen is increased and video is complicated, the exiting video codec used for encoding the video has a limitation in coding efficiency.

Therefore, in order to more improve a compression rate recently, research into new video encoding has been actively conducted. To this end, research (High-Efficiency Video Coding (HEVC)) for increasing coding efficiency two times higher than the existing codec by using a coding unit (for example, 2N×2N, N=4, 8, 16, 32, and the like) extending a macroblock (MB) in a 16×16 pixel unit that is a basic coding unit for coding used in H.264 has been conducted.

However, as a size of the basic coding unit is extended, computation for motion estimation in an inter prediction unit that occupies most of computation in the encoders is relatively increased, which leads to degradation in performance of all the encoders.

The inter prediction unit estimates a motion vector in a reference prediction block 2N×2N and additionally divides a rate for more accurately performing screen prediction to perform each motion estimation for 2N×N, N×2N, and N×N (for example, in case of H.264 in which N=8, there is sub-macroblock partition that is N/2×N, N×N/2, and N/2×N/2) blocks and decide one mode in which rate-distortion is minimum among at least four modes.

Meanwhile, a method for calculating a sum of absolute difference (SAD) that obtains a sum of absolute values for all the pixels of a current pixel and a reference video or a method for calculating a sum of absolute error (SAE) using a difference of a square has been used so as to perform the motion estimation for predicting the motion vector. In addition to the foregoing methods, a method for calculating rate distortion optimization (RDO) deciding a final mode in consideration of a generated amount of a final bit is used for more accurate prediction.

In case of the calculation methods, the coding cost for each of the foregoing four modes or more is calculated and finally, the mode in which the generation of a bit rate is smallest is selected and therefore, huge computation may be required and coding time is remarkably increased. As a result, it is difficult to apply the calculation methods to a real-time video encoder.

An example of the related arts may include Korean Patent Laid-Open No. 2011-0065102 (Published in Jun. 15, 2011, Title: Method and apparatus for fast motion estimation and video encoding apparatus using the same).

The above-mentioned technical configuration is a background art for helping understanding of the present invention and does not mean related arts well known in a technical field to which the present invention pertains.

### SUMMARY

An embodiment of the present invention is to provide a method for deciding motion partition capable of rapidly deciding a motion partition mode using motion vector information of neighboring blocks and an encoder.

Further, an embodiment of the present invention is to provide a method for deciding motion partition capable of performing real-time encoding in high-resolution and high-complexity video by shortening time required for motion estimation and improving performance of an encoder and an encoder.

An embodiment of the present invention relates to a method for deciding a motion partition mode executed by an encoder, including: reading, by a motion partition mode decision unit, motion vector information of one or more neighboring blocks decided as an inter mode among neighboring blocks of a current prediction unit C₀ from a motion vector storage unit; and deciding, by the motion partition mode decision unit, the motion partition mode for the current prediction unit using the read motion vector information.

In the deciding of the motion partition mode, the motion partition mode decision unit may decide the motion partition mode for the current prediction unit by using a first average motion value that is an average of a sum of absolute values of motion vectors of the neighboring blocks decided as an inter mode located at the left and a second average motion value that is an average of a sum of absolute values of motion vectors of the neighboring blocks decided as an inter mode located at the top, based on the current prediction unit.

In the deciding of the motion partition mode, the motion partition mode decision unit may obtain a third average motion value that is a sum of average motion values in an X direction and a fourth average motion value that is a sum of average motion values in a Y direction by using the first average motion value and the second average motion value and then, decide the motion partition mode for the current prediction unit as a 2N×2N motion partition mode when an absolute value of a difference between the third average motion value and the fourth average motion value is 0 or a first threshold a or less that is any real number.

In the deciding of the motion partition mode, the motion partition mode decision unit may decide the motion partition mode of the current prediction unit as an N×N motion partition mode when the absolute value of a difference between the third average motion value and the fourth average motion value is larger than the first threshold and a second threshold β (any real number larger than the first threshold value) that is any real number.

In the deciding of the motion partition mode, the motion partition mode decision unit may decide the motion partition mode of the current prediction unit as a 2N×N motion partition mode when the absolute value of a difference between the third average motion value and the fourth average motion value is larger than the second threshold and the third average motion value is larger than the fourth average motion value.

In the deciding of the motion partition mode, the motion partition mode decision unit may decide the motion partition mode of the current prediction unit as an N×2N motion partition mode when the absolute value of a difference between the third average motion value and the fourth average motion value is larger than the second threshold and the third average motion value is smaller than the fourth average motion value.

The method for deciding a motion partition mode may further include: performing, by the motion prediction unit, the motion prediction on the current prediction unit according to the motion partition mode decided by the motion partition mode decision unit and storing the motion vector information that is a result obtained by performing the motion prediction in the motion vector storage unit.

Another embodiment of the present invention relates to an encoder including an inter prediction unit, wherein the inter prediction unit may include: a motion vector storage unit configured to store previously predicted motion vector information of neighboring blocks of a current prediction unit; and a motion partition mode decision unit configured to read motion vector information of one or more neighboring blocks decided as an inter mode among neighboring blocks of the current prediction unit from a motion vector storage unit and decide the motion partition mode for the current prediction unit using the read motion vector information.

The motion partition mode decision unit may decide the motion partition mode for the current prediction unit by using a first average motion value that is an average of a sum of absolute values of motion vectors of the neighboring blocks decided as an inter mode located at the left and a second average motion value that is an average of a sum of absolute values of motion vectors of the neighboring blocks decided as an inter mode located at the top, based on the current prediction unit.

The motion partition mode decision unit may obtain a third average motion value that is a sum of average motion values in an X direction and a fourth average motion value that is a sum of average motion values in a Y direction by using the first average motion value and the second average motion value and then, decide the motion partition mode for the current prediction unit as a 2N×2N motion partition mode when an absolute value of a difference between the third average motion value and the fourth average motion value is 0 or a first threshold α or less that is any real number.

The motion partition mode decision unit may decide the motion partition mode of the current prediction unit as an N×N motion partition mode when the absolute value of a difference between the third average motion value and the fourth average motion value is larger than the first threshold and a second threshold β (any real number larger than the first threshold value) that is any real number.

The motion partition mode decision unit may decide the motion partition mode of the current prediction unit as a 2N×N motion partition mode when the absolute value of a difference between the third average motion value and the fourth average motion value is larger than the second threshold and the third average motion value is larger than the fourth average motion value.

The motion partition mode decision unit may decide the motion partition mode of the current prediction unit as an N×2N motion partition mode when the absolute value of a difference between the third average motion value and the fourth average motion value is larger than the second threshold and the third average motion value is smaller than the fourth average motion value.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram showing a configuration of an inter prediction unit for performing a method for deciding a motion partition mode in accordance with an embodiment of the present invention;

FIG. 2 is a diagram illustrating a general motion partition mode;

FIG. 3 is a diagram illustrating a current prediction unit and motion-partitioned neighboring blocks;

FIG. 4 is a flow chart schematically illustrating a method for deciding a motion partition mode in accordance with an embodiment of the present invention; and

FIG. 5 is a flow chart illustrating in detail a process of deciding the motion partition mode of FIG. 4.

### DESCRIPTION OF SPECIFIC EMBODIMENTS

Hereinafter, a method for deciding a motion partition mode and an encoder in accordance with an embodiment of the present invention will be described in detail with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

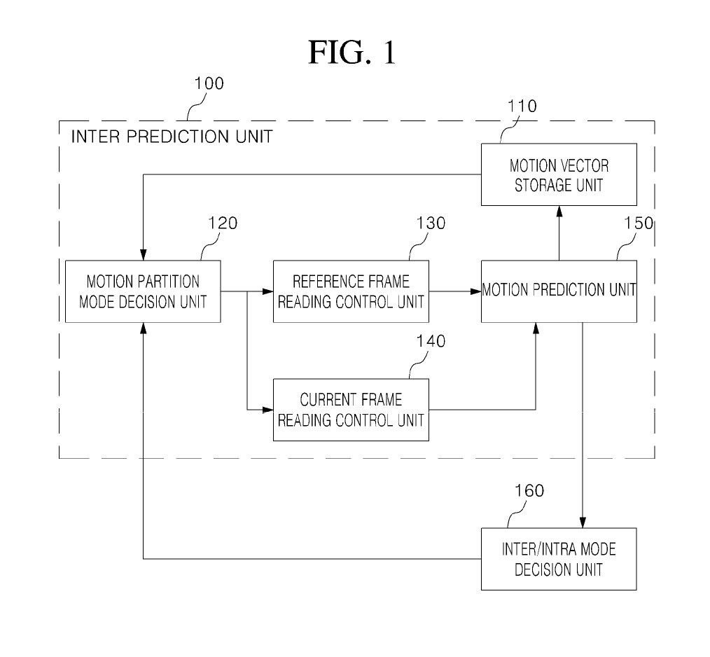

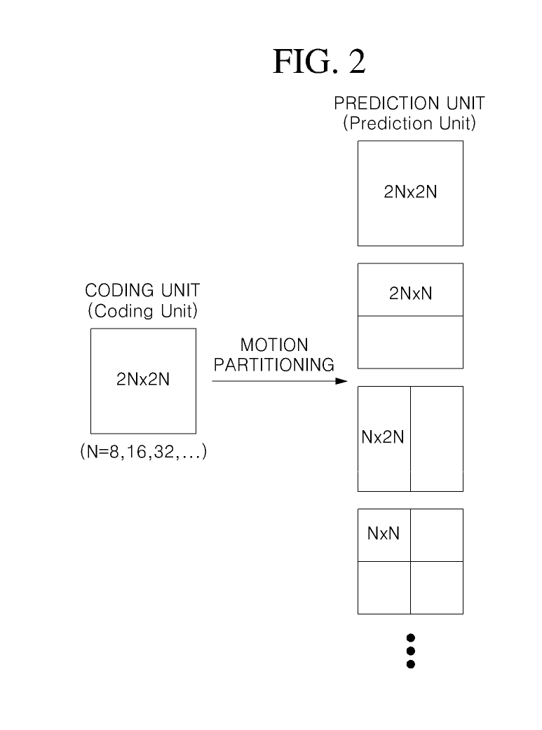

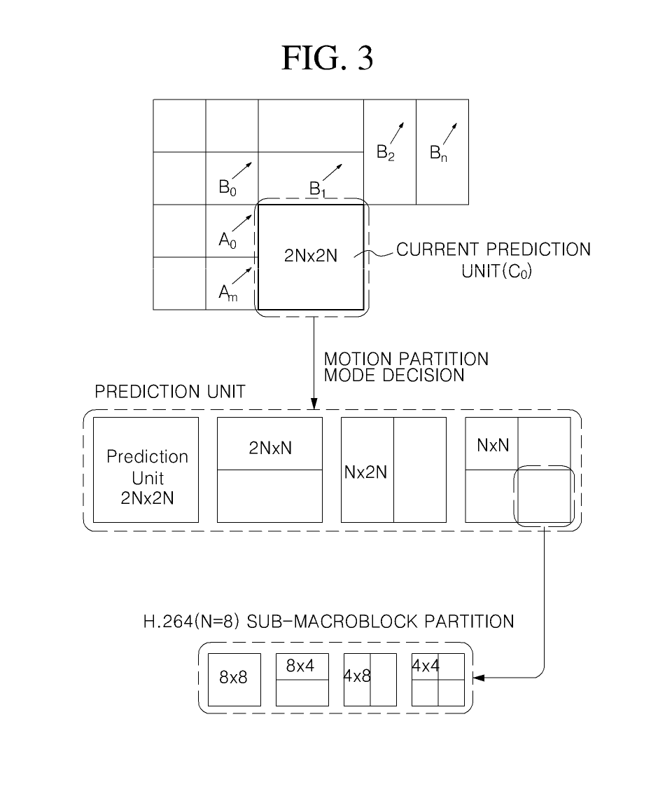

FIG. 1 is a block diagram illustrating a configuration of an inter prediction unit for performing a method for deciding a motion partition mode in accordance with an embodiment of the present invention, FIG. 2 is a diagram illustrating a general motion partition mode, and FIG. 3 is a diagram illustrating a current prediction unit and motion-partitioned neighboring blocks.

As illustrated in FIG. 1, an inter prediction unit 100 may be configured to include a motion vector storage unit 110, a motion partition mode decision unit 120, a reference frame reading control unit 130, a current frame reading control unit 140, and a motion prediction unit 150. The inter prediction unit 100 may use mode decision information that is provided from an inter/intra mode decision unit 160 as described below.

In addition, an encoder (not illustrated) including the inter prediction unit 100 may further include an intra prediction unit (not illustrated) for optimal encoding mode decision for a current prediction unit C₀ (see FIG. 3) and is apparent to those skilled in the art and slightly deviates from a gist of the present invention, and therefore, a description thereof will be omitted.

The inter prediction unit 100 in accordance with the embodiment of the present invention decides the motion partition mode in advance by using motion vectors of the neighboring blocks located at the top and left of the current prediction unit to be encoded and performs motion prediction only on the decided motion partition mode, thereby reducing excessive computation occurring during the process of deciding the optimal inter mode by the inter prediction unit 100.

The motion vector storage unit 110 stores the motion vector information on each of the predicted neighboring blocks according to motion estimation results by the motion prediction unit 150.

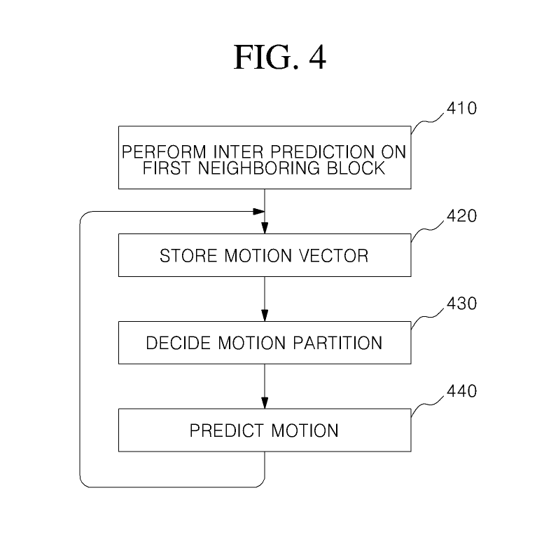

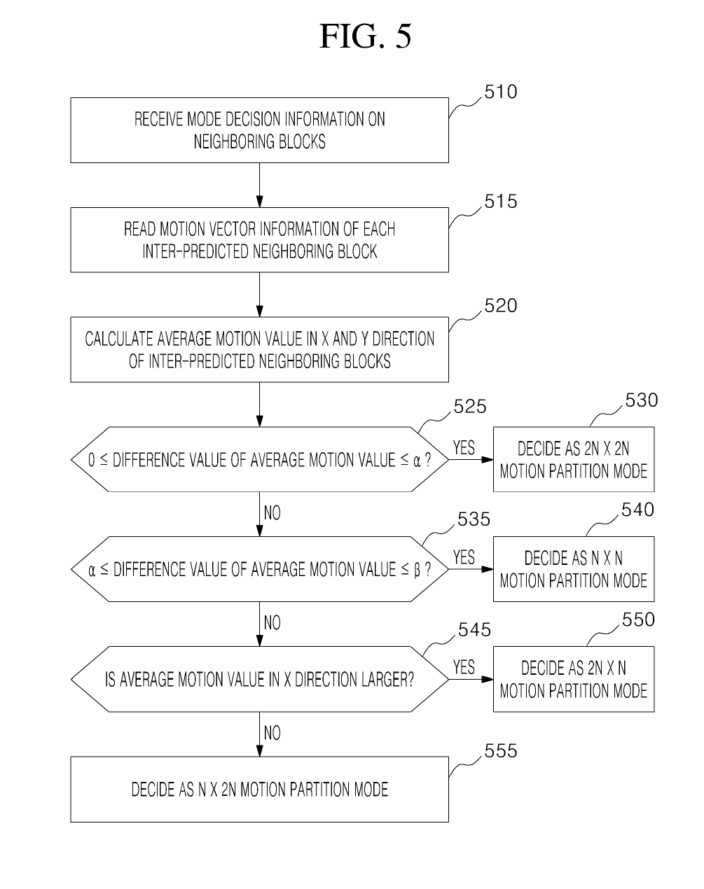

The motion partition mode decision unit 120 receives the motion vector information of the neighboring blocks decided as an inter mode by using the mode decision information (for example, the decision information by the inter mode or the intra mode) on the neighboring blocks of the current prediction unit C₀ that is provided from an inter/intra mode decision unit 170, thereby deciding the motion partition mode for the current prediction unit C₀ at an early stage. The method for deciding a motion partition mode performed by the motion partition mode decision unit 120 will be described below with reference to FIGS. 4 and 5.

For reference, FIG. 2 illustrates a general motion partition mode and FIG. 3 illustrates the current prediction unit C₀ and the motion-partitioned neighboring blocks.

The size of the encoding unit in the inter prediction may be variously changed according to a motion partition division depth of encoding according to a type of an input video and therefore, it is apparent that the motion partition mode is various, such as 2N×2N, 2N×N, N×2N, N×N, and the like, as illustrated in FIG. 2.

In addition, as illustrated in FIG. 3 illustrating the current prediction unit C₀ and the motion-partitioned neighboring blocks, since the video is generally encoded in a raster scan sequence, the neighboring blocks (that is, illustrated by Aₒ to Aₙ in FIG. 3) located at the left and the neighboring blocks (that is, illustrated by Bₒ to Bₙ in FIG. 3) located at the top based on the current prediction unit C₀ are encoded in advance. Here, in the inter mode in which N=8 in H.264, the sub-macroblock partition having a size of 8×8, 8×4, and 4×4 is additionally present. An arrow illustrated in FIG. 3 arbitrarily illustrates the direction and size of the motion vectors at each of the neighboring blocks but is not limited thereto.

Referring again to FIG. 1, the reference frame reading control unit 130 and the current frame reading control unit 140 perform a control to read out pixel values required to process the motion estimation for the current prediction unit Co, and the like, by using the motion partition mode decision information by the motion partition mode decision unit 120. The pixel values read out by the reference frame reading control unit 130 and the current frame reading control unit 140 are provided to the motion prediction unit 150 for processing the motion prediction.

The motion prediction unit 150 performs the motion prediction processing on the current prediction unit Co by using pixel values that are read out, controlled, and provided by the reference frame reading control unit 130 and the current frame reading control unit 140. The motion vector information according to the motion prediction processing is stored in the motion vector storage unit 110.

Hereinafter, an operation of the inter prediction unit 100 will be briefly described with reference to the accompanying drawings.

In the state in which the neighboring blocks (for example, blocks located at the top and left for the current prediction unit C₀) subjected to the motion prediction by performing the inter prediction is stored in the motion vector storage unit 110 of the inter prediction unit 100, the motion partition mode decision unit 120 receives the mode decision information on which each neighbor block is decided as the inter mode from the inter/intra mode decision unit 160 for deciding the motion partition mode of the current prediction unit C₀ or on whether each neighbor block is decided as the intra mode.

Next, the motion partition mode decision unit 120 reads the motion vector information of each neighboring block that is decided as the inter mode among the motion vector information stored in the motion vector storage unit 110 and decides the motion partition mode by using the method for deciding a predetermined motion partition mode.

The reference frame reading control unit 130 and the current frame reading control unit 140 perform a control to read out pixel values required to process the motion estimation for the current prediction unit C₀, and the like, by using the motion partition mode decision information by the motion partition mode decision unit 120 and the motion prediction unit 150 performs the motion prediction processing by using the provided pixel values.

FIG. 4 is a flow chart schematically illustrating a method for deciding a motion partition mode in accordance with an embodiment of the present invention and FIG. 5 is a flow chart illustrating in detail a process of deciding the motion partition mode of FIG. 4.

Referring to FIG. 4 in which the method for deciding a motion partition mode of the inter prediction unit 100 at an early stage is illustrated, in S410, the inter prediction unit 100 performs the inter prediction on all the motion partition modes of a first neighboring block to be currently encoded and stores the motion vector information that is the results of the inter prediction in the motion vector storage unit 110 by proceeding to S420. Here, the first neighboring block, which is, for example, a first prediction unit that performs the inter prediction, may be the prediction unit in the state in which the neighboring blocks subjected to the inter prediction in advance are not present.

Then, the inter prediction unit 100 receives the mode decision information on each neighboring block (that is, the block in which the motion vector information subjected to the inter prediction is stored in the motion vector storage unit 110) in S430, reads the motion vector information of each neighboring block decided as the inter mode from the motion vector storage unit 110, and then, decides the motion partition mode by using the method for deciding a predetermined motion partition mode. Hereinafter, the method for deciding a motion partition mode will be described in detail with reference to FIG. 5.

Then, the inter prediction unit 100 performs the motion prediction by using the pixel values corresponding to the current prediction unit C₀ of which the motion partition mode is decided in S440 and stores the motion vector information according to the motion prediction in the motion vector storage unit 110 by proceeding to S420 again.

Referring to FIG. 5 in which the deciding of the motion partition mode of FIG. 4 is illustrated in detail, the motion partition mode decision unit 120 receives the mode decision information on each neighboring block (that is, the block in which the motion vector decision unit 160 subjected to the inter prediction is stored in the motion vector storage unit 110) provided from the inter/intra mode decision unit 160 in S510 and reads the motion vector information of each peripheral block decided as the inter mode by the mode decision information from the motion vector storage unit 110 by proceeding to S515.

In S520, the motion partition mode decision unit 120 calculates an average motion value in an X direction and a Y direction by using the motion vector information read from the motion vector storage unit 110.

Here, the average motion value means an average of a sum of absolute values of the motion vector values for the neighboring blocks decided as the inter mode, which may be calculated by each of the following Equations 1 and 2.

For reference, as illustrated in FIG. 3, Equation 1 is an Equation for obtaining the average motion value (that is, an average of a sum of the absolute values of all the motion vectors) for the neighboring blocks decided as the inter mode among the neighboring blocks (that is, represented by Aₒ to Aₘ) located the left based on the current prediction unit C₀ and Equation 2 is an Equation for obtaining the average motion value for neighboring blocks decided as the inter mode among the neighboring blocks (that is, represented by Bₒ to Bₙ) located at the top based on the current prediction unit C₀.

$$\begin{matrix}Ave [ ( MV ( A ( X , Y ) ) ] ) = \frac{{\sum }_{0}^{M} \vert MV ( {A}_{n} ) \vert}{M} \\ = \{ \begin{matrix}Ave [ MV ( A ( X ) ] , \\ Ave [ MV ( A ( Y ) ]\end{matrix} \}\end{matrix} \qquad [ Equation 1 ]$$

In the above Equation 1, M represents a total sum of the neighboring blocks of the left decided as the inter mode and X and Y each are the horizontal and vertical motion vector values.

$$\begin{matrix}Ave [ ( MV ( B ( X , Y ) ) ] ) = \frac{{\sum }_{0}^{N} \vert MV ( {B}_{0} ) \vert}{N} \\ = \{ \begin{matrix}Ave [ MV ( B ( X ) ] , \\ Ave [ MV ( B ( Y ) ]\end{matrix} \}\end{matrix} \qquad [ Equation 2 ]$$

In Equation 2, N represents a total sum of the neighboring blocks of the top decided as the inter mode.

Generally, the motion direction (motion vector) of the video has much correlation with the neighboring blocks and therefore, the inter prediction unit 100 in accordance with the present embodiment applies the method for deciding a motion partition mode that decides the motion partition mode of the current prediction unit by using the average motion value according to the motion vector information of the neighboring blocks.

In S525, the motion partition mode decision unit 120 calculates the sum of the average motion values in the X direction and the Y direction for all the neighboring blocks (that is, the neighboring blocks located at the left and top) predicted as the inter mode and then, decides whether the absolute value of the difference therebetween is 0 or more or is a first threshold α or less, as represented by the following Equation 3.

$$[ \vert \begin{matrix}Σ ( Ave [ MV ( A ( X ) ] , Ave [ MV ( B ( X ) ] ) - \\ Σ ( Ave [ MV ( A ( Y ) ] , Ave [ MV ( B ( Y ) ] )\end{matrix} \vert \{ \begin{matrix}= 0 \\ OR \\ \leq α\end{matrix} \} ] \qquad [ Equation 3 ]$$

If it is decided the absolute value of the difference in the average motion values is 0 or more and is the first threshold α or less by the decision of S25, the motion partition mode decision unit 120 decides the motion partition mode of the current prediction unit as 2N×2N by proceeding to S530. The reason is that the current prediction unit can predict that no video motion is or video motion is less.

However, when the conditions for decision in S525 are not satisfied, the motion partition mode decision unit 120 decides whether the absolute value of the difference in the sum of the average motion values in the X direction and the Y direction for all the neighboring blocks predicted as the inter mode is larger than a first threshold value and is a second threshold β or less, as represented by the following Equation 4. Here, the second threshold is any real number larger than the first threshold.

[|Σ(Ave[MV(A(X)],Ave[MV(B(X)])−Σ(Ave[MV(A(Y)],Ave[MV(B(Y)])|≦β] [Equation 4]

If it is decided the absolute value of the difference in the average motion values is 0 or more and is the first threshold α or more and the second threshold β or less by the decision of S25, the motion partition mode decision unit 120 decides the motion partition mode of the current prediction unit as N×N by proceeding to S540. The reason is that the current prediction unit can predict that the video motion has considerable fine motion in horizontal, vertical, and diagonal directions rather than being biased to any one of the horizontal direction and the vertical direction.

However, when the conditions for decision in S535 are not satisfied, the motion partition mode decision unit 120 decides whether the sum of the average motion values in the X direction is larger than the sum of the motion values in the Y direction by proceeding to S545. This is to decide whether the movement is mainly made in any direction when the conditions of the foregoing Equation 4 are not satisfied (that is, when the absolute value of the difference in the average motion values is larger than the second threshold), that is, when the motion vectors of the neighboring blocks are biased to any one of the horizontal direction and the vertical direction.

If it is decided that the sum of the average motion values in the X direction is larger than the sum of the motion values in the Y direction by the decision of S545 (see the following Equation 5), the movement is mainly made in the horizontal direction rather than in the vertical direction and therefore, the motion partition mode decision unit 120 decides the motion partition mode of the current prediction unit as 2N×N in step 550.

[(Σ(Ave[MV(A(X)],Ave[MV(B(X)])>Σ(Ave[MV(A(Y)],Ave[MV(B(Y)])] [Equation 5]

However, if it is decided that the sum of the average motion values in the X direction is smaller than the sum of the motion values in the Y direction by the decision of S545 (see the following Equation 6), the movement is mainly made in the vertical direction rather than in the horizontal direction and therefore, the motion partition mode decision unit 120 decides the motion partition mode of the current prediction unit as N×2N in step 550.

[(Σ(Ave[MV(A(X)],Ave[MV(B(X)])<Σ(Ave[MV(A(Y)],Ave[MV(B(Y)])] [Equation 6]

The motion prediction according to the motion partition mode of the current prediction unit decided by the foregoing processes is performed by the motion prediction unit 150, such that the motion vector information will be stored in the motion vector storage unit 110, thereby performing the motion partition mode decision of the subsequent prediction unit.

As described above, the inter prediction unit 100 in accordance with the embodiment of the present invention decides the single motion partition mode by using the method for deciding a motion partition mode as described above after more than one motion vector information is stored in the motion vector storage unit 110 and performs the inter prediction only on the motion partition mode, thereby shortening the time required for the motion estimation and improving the performance of the encoder. Here, even when there is the motion partition (sub-macroblock) division like N=8 of H.264, and the like, the process illustrated in FIGS. 4 and/or 5 are repeatedly performed, thereby rapidly deciding the single motion partition mode.

When using the method for deciding a motion partition mode in accordance with the embodiment of the present invention, the computation necessary for the motion estimation required for encoding is reduced within the range in which a peak signal-to-noise ratio of excellent quality of image is tolerable, thereby improving the performance of the encoder. As a result, the apparatus for performing real-time encoding can be implemented.

In addition, the method for deciding a motion partition mode as described above may also be performed by an automated procedure according to a time series sequence by the software program, and the like, that is embedded in the digital processing apparatus. The codes and code segments configuring the program may be easily derived by computer programmers in the art. In addition, the program is stored in a computer readable media that can be readable by the digital processing apparatus and is read and executed by the digital processing apparatus, which results in implementing the method. An example of the computer readable media may include a magnetic recording medium, an optical recording medium, and a carrier wave medium.

In accordance with the embodiments of the present invention, it is possible to rapidly decide the motion partition mode of the current prediction unit based on the motion vector information of the neighboring blocks in consideration of the fact that the video motion in the current prediction unit for performing the current inter prediction has the correlation similar to the direction of the motion vectors existing in the neighboring blocks in characteristics.

Further, in accordance with the embodiments of the present invention, it is possible to perform the real-time encoding in the high-resolution and high-complexity video by shortening the time required for the motion estimation and improving the performance of the encoder.

Although the embodiments of the present invention have been described in detail, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. A method for deciding a motion partition mode executed by an encoder, comprising:
reading, by a motion partition mode decision unit, motion vector information of one of more neighboring blocks decided as an inter mode among neighboring blocks of a current prediction unit C₀ from a motion vector storage unit; and
deciding, by the motion partition mode decision unit, the motion partition mode for the current prediction unit using the read motion vector information.

2. The method of claim 1, wherein in the deciding of the motion partition mode, the motion partition mode decision unit decides the motion partition mode for the current prediction unit by using a first average motion value that is an average of a sum of absolute values of motion vectors of the neighboring blocks decided as an inter mode located at the left and a second average motion value that is an average of a sum of absolute values of motion vectors of the neighboring blocks decided as an inter mode located at the top, based on the current prediction unit.

3. The method of claim 2, wherein in the deciding of the motion partition mode, the motion partition mode decision unit obtains a third average motion value that is a sum of average motion values in an X direction and a fourth average motion value that is a sum of average motion values in a Y direction by using the first average motion value and the second average motion value and then, decides the motion partition mode for the current prediction unit as a 2N×2N motion partition mode when an absolute value of a difference between the third average motion value and the fourth average motion value is 0 or a first threshold α or less that is any real number.

4. The method of claim 3, wherein in the deciding of the motion partition mode, the motion partition mode decision unit decides the motion partition mode of the current prediction unit as an N×N motion partition mode when the absolute value of a difference between the third average motion value and the fourth average motion value is larger than the first threshold and a second threshold β (any real number larger than the first threshold value) that is any real number.

5. The method of claim 4, wherein in the deciding of the motion partition mode, the motion partition mode decision unit decides the motion partition mode of the current prediction unit as a 2N×N motion partition mode when the absolute value of a difference between the third average motion value and the fourth average motion value is larger than the second threshold and the third average motion value is larger than the fourth average motion value.

6. The method of claim 4, wherein in the deciding of the motion partition mode, the motion partition mode decision unit decides the motion partition mode of the current prediction unit as an N×2N motion partition mode when the absolute value of a difference between the third average motion value and the fourth average motion value is larger than the second threshold and the third average motion value is smaller than the fourth average motion value.

7. The method of claim 1, further comprising: performing, by the motion prediction unit, the motion prediction on the current prediction unit according to the motion partition mode decided by the motion partition mode decision unit and storing the motion vector information that is a result obtained by performing the motion prediction in the motion vector storage unit.

8. An encoder including an inter prediction unit, wherein the inter prediction unit includes:
a motion vector storage unit configured to store previously predicted motion vector information of neighboring blocks of a current prediction unit; and
a motion partition mode decision unit configured to read motion vector information of one or more neighboring blocks decided as an inter mode among neighboring blocks of the current prediction unit from a motion vector storage unit and decide the motion partition mode for the current prediction unit using the read motion vector information.

9. The encoder of claim 8, wherein the motion partition mode decision unit decides the motion partition mode for the current prediction unit by using a first average motion value that is an average of a sum of absolute values of motion vectors of the neighboring blocks decided as an inter mode located at the left and a second average motion value that is an average of a sum of absolute values of motion vectors of the neighboring blocks decided as an inter mode located at the top, based on the current prediction unit.

10. The encoder of claim 9, wherein the motion partition mode decision unit obtains a third average motion value that is a sum of average motion values in an X direction and a fourth average motion value that is a sum of average motion values in a Y direction by using the first average motion value and the second average motion value and then, decides the motion partition mode for the current prediction unit as a 2N×2N motion partition mode when an absolute value of a difference between the third average motion value and the fourth average motion value is 0 or a first threshold a or less that is any real number.

11. The encoder of claim 10, wherein the motion partition mode decision unit decides the motion partition mode of the current prediction unit as an N×N motion partition mode when the absolute value of a difference between the third average motion value and the fourth average motion value is larger than the first threshold and a second threshold β (any real number larger than the first threshold value) that is any real number.

12. The encoder of claim 10, wherein the motion partition mode decision unit decides the motion partition mode of the current prediction unit as a 2N×N motion partition mode when the absolute value of a difference between the third average motion value and the fourth average motion value is larger than the second threshold and the third average motion value is larger than the fourth average motion value.

13. The encoder of claim 10, wherein the motion partition mode decision unit decides the motion partition mode of the current prediction unit as an N×2N motion partition mode when the absolute value of a difference between the third average motion value and the fourth average motion value is larger than the second threshold and the third average motion value is smaller than the fourth average motion value.
